(19) United States
(12) Patent Application Publication
(10) Pub. No.: US 2020/0300379 A1
(43) Pub. Date: Sep. 24, 2020

(54) GAS VALVE

(71) Applicant: STRAUSS WATER LTD, Or Yehuda (IL)

(72) Inventors: Haim WILDER, Ra'anana (IL); Gil YARDENI, Or-Yehuda (IL); Xu FENGMING, Wuhan, Hubei (CN)

(73) Assignee: STRAUSS WATER LTD, Or Yehuda (IL)

(21) Appl. No.: 16/771,608

(22) PCT Filed: Dec. 10, 2018
(86) PCT No.: PCT/IL2018/051343

§ 371 Date: Jun. 10, 2020

(30) Foreign Application Priority Data
Dec. 10, 2017 (IL) 256227

(51) Int. Cl. F16K 31/122; B67D 1/12; F16K 41/10; B67D 1/00; G05D 16/10; B01F 3/04

(52) U.S. Cl. CPC F16K 31/1221; B67D 1/1252; F16K 41/10; B67D 1/0069; A23L 2/54; B01F 3/04808; B01F 2003/049; B01F 2215/0022; G05D 16/103

(57) ABSTRACT

Provided is a gas valve, particularly configured for use in a water carbonation system or appliance; and further provided is a system or appliance including such a valve.

### TECHNOLOGICAL FIELD

This disclosure concerns a gas valve, particularly suitable for use in a water carbonation system or appliance; and also concerns a system or appliance comprising such a valve.

### BACKGROUND ART

References considered to be relevant as background to the presently disclosed subject matter are listed below:
PCT application publication no. WO 2014/041539
PCT application publication no. WO 2015/118523
PCT application no. PCT/IL2017/051107
PCT application publication WO 2017/134014
U.S. Pat. No. 4,818,444
US 2005/0034758
US 2012/0111433

Acknowledgement of the above references herein is not to be inferred as meaning that these are in any way relevant to the patentability of the presently disclosed subject matter.

### BACKGROUND

Systems and appliances for preparation of carbonated beverages are known, for example from WO 2014/041539, WO 2015/118523, and PCT/IL2017/051107. These PCT applications disclose on-demand carbonation systems that make use of carbon dioxide gas and liquid that are simultaneously fed into a carbonation chamber to thereby produce a carbonated beverage. Both feeds need to be activated or deactivated simultaneously.

### GENERAL DESCRIPTION

Provided by this disclosure is a gas valve that operates to permit gas flow concurrently with a change of liquid flow dynamic in a liquid flow system. A particular use of the gas valve is in water carbonation systems and appliances for on demand preparation of a carbonated water-based beverage. The gas valve of this disclosure operates to permit gas flow upon water flow induction and the water flow and the gas flow may be combined, in a carbonation unit, for the preparation of said beverage.

Also provided by this disclosure is a water carbonation system comprising such a gas valve.

The gas valve comprises a gas passage, a piston mechanism and a liquid chamber in communication with a liquid flow duct. The gas passage is defined between a gas inlet port and a gas outlet port and comprises a valve unit switchable between a gas flow-arresting state and a gas flow permitting state, permitting gas flow from the inlet port to the outlet port. The piston mechanism comprises a piston member coupled to the valve unit and configured, through axial displacement of the piston member between first and second positions, to induce the valve unit to respectively switch between its gas flow-arresting state and a gas flow permitting state. As the liquid chamber is in communication with said duct, change in liquid pressure in said flow duct or change in the liquid flow dynamics through said duct induces a change in static pressure within the liquid chamber to thereby induce displacement of the piston. Such displacement then causes a respective switch of the valve unit to thereby permit gas flow through said gas passage concurrently with the water flow.

By one embodiment, the piston mechanism comprises a flexible liquid-impermeable diaphragm separating between the piston member and the liquid chamber and coupled to the piston member such that deformation of the diaphragm induces displacement of the piston member.

The valve unit may comprise a valve plunger that is disposed in a valve seat, the plunger being coupled to the piston member such that its switch between the gas flow-arresting state and the gas flow permitting state is through axial movement. The piston member and the valve plunger are typically coupled to one another in a fixed manner such that axial displacement of the piston member causes a concomitant axial displacement of the valve plunger.

The gas valve is typically configured such that an increase in static pressure within the liquid chamber induces the displacement of the piston member from the first to the second position. The piston member may be biased into its first position by a biasing arrangement and the displacement into the second position is against such bias.

Notwithstanding the typical configuration noted in the previous paragraph, the piston member may also be configured for displacement into its second position by a decrease in static pressure within said liquid chamber. A decrease in static pressure may occur in the case where the duct is in direct communication with a liquid source and accordingly the steady-state pressure within said chamber is essentially that of the source. When water is permitted to flow, through a downstream valve, the increase in flow causes a drop in static pressure in the duct and hence also in said chamber. The pressure decrease-induced piston member displacement will then cause the corresponding switch in the valve plunger.

It is of note that once gas flow is permitted by the valve, pressurized gas flows from the pressurized (e.g. CO₂) source towards the gas outlet port for its utilization by an appliance associated with or connected to the valve. As the gas is typically stored within the gas source (e.g. a pressurized gas container) at a relatively high pressure, gas flow through the valve typically causes abrupt reduction in the pressure, and hence abrupt expansion of the gas. Such expansion is typically endothermic, and hence is accompanied by a temperature drop at the gas outlet port. In order to minimize or prevent formation of water condensate or ice at the gas outlet port, the valve may, by an embodiment, further comprise a freezing-preventing module fitted at or associated with the gas outlet port. Such a freezing-preventing module is typically made of a material having a high heat conductivity, such as an metal or an alloy, and is typically designed to have a large surface area, e.g. porous, thus disrupting the flow of gas through the gas outlet port, thus reducing the rate of gas expansion and preventing formation of condensate.

By another aspect of this disclosure, there is provided a gas valve that comprises a gas passage defined between a gas inlet port and a gas outlet port and comprising a valve unit disposed between the gas inlet port and gas outlet port and switchable between a gas flow-arresting state and a gas flow permitting state, permitting gas flow from the inlet port to the outlet port; a piston mechanism comprising a piston member coupled to the valve unit and configured, through axial displacement of the piston member between first and second positions, to induce the valve unit to respectively switch between its gas flow-arresting state and a gas flow permitting state; a liquid chamber in communication with a liquid flow duct such that a change in liquid pressure in said flow duct or liquid flow dynamics through said duct induces a change in static pressure within the liquid chamber to thereby induce displacement of the piston, the piston mechanism further comprises a flexible liquid-impermeable diaphragm separating between the piston member and the liquid chamber and coupled to the piston member, increase in the static pressure within the liquid chamber causes deformation of the diaphragm to induces displacement of the piston from the first to the second position, and hence cause the valve unit to switch from gas flow-arresting state to said gas flow-permitting state.

Provided by this disclosure is also a water carbonation system that comprises a water flow system between a water source and a carbonation unit, a gas flow system between a pressurized carbon-dioxide source and the carbonation unit in which the water and the carbon-dioxide are combined to produce carbonated water; and a gas valve of the kind described above. The liquid duct of said valve is disposed in and constitutes a part of the water flow system to channel water flow from the source to the carbonation unit to flow through said duct. The gas passage of said valve is disposed in and constitutes a part of the gas flow system, such that carbon dioxide flows from the source to the carbonation unit through said gas passage. Water flow through said duct induces a change in static pressure within the liquid chamber to thereby induce displacement of the piston to permit gas flow into the carbonation unit concurrently with the flow of water.

The carbonation system typically comprises a liquid flow control valve upstream in the water flow system to said liquid duct, whereby opening of the valve to permit water flow through said duct increased static pressure within the water chamber to thereby cause the piston to displace from its first to its second position.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A shows a schematic cross-section through a gas valve according to an embodiment of this disclosure, in a gas flow-arresting state.

FIG. 1B shows a schematic cross-section through a gas valve according to another embodiment of this disclosure, in a gas flow-arresting state

FIG. 2 shows a schematic cross-section of the gas valve of FIG. 1A in a gas flow-permitting state.

FIG. 3 shows a schematic cross-section through a gas valve according to an embodiment of this disclosure that includes a module for preventing ice formation due to expansion of the gas at the gas outlet of the valve.

FIG. 4 is a block diagram of carbonation system embodying a valve of the kind shown in FIGS. 1-3.

### DETAILED DESCRIPTION OF EMBODIMENTS

In the following description the invention will be illustrated with some details in reference to specific embodiments of a gas valve that illustrates the features of this disclosure. This illustration is exemplary and non-limiting of the disclosure in its full scope as described.

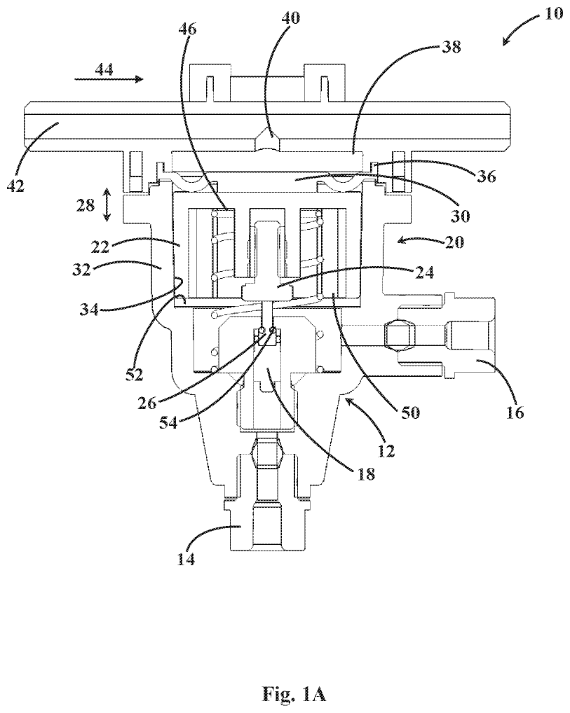

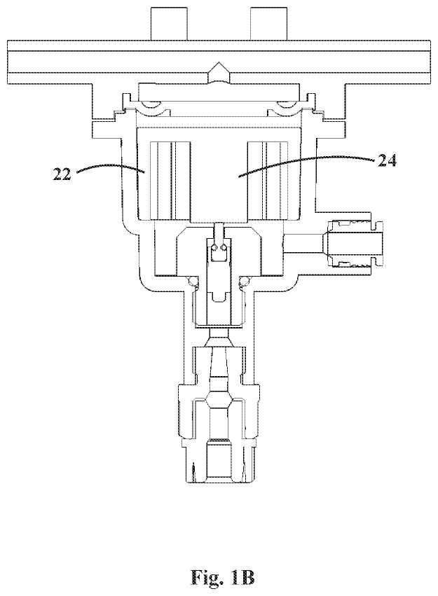

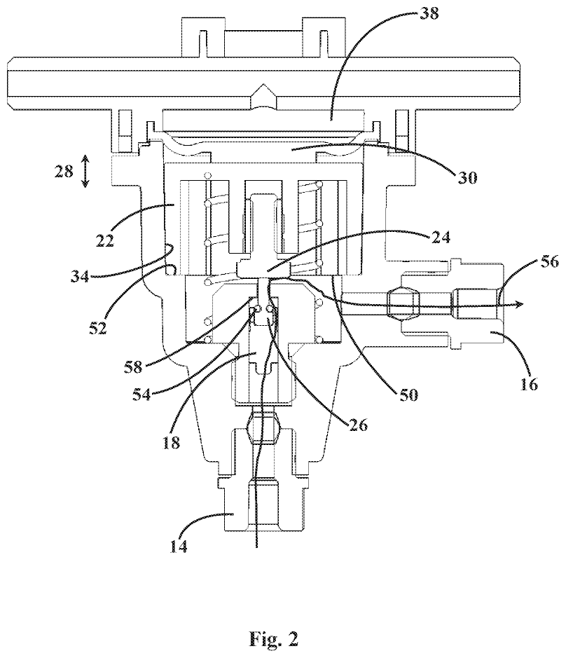

In the following for sake of convenience the gas valve described in FIGS. 1 and 2 will be described in reference to an upward-downward orientation. Direction towards the bottom of the figure will be regarded as “downward” and direction towards the top of the figure will be regarded as “upward”. Similarly, the respective top and bottom portions of the figure will be related to as such. This, as may be appreciated, does not necessarily have any functional significance and in actual use the valve may have a different orientation, e.g. it may be reversed, laterally rotated, etc.

Gas valve 10 shown in FIG. 1A includes a gas passage 12 defined between a gas inlet port 14 and a gas outlet port 16 and comprising a valve unit 18. The valve unit 18 comprises a piston mechanism 20 with a piston member 22 coupled to the valve unit through coupling member 24 that is fixedly associated with a valve plunger 26. In another configuration, shown in FIG. 1B, the coupling member 24 is an integral part of piston member 22. Consequently, through axial displacement of the piston member in a direction represented by arrow 28 between a first position shown in FIG. 1A and a second position shown in FIG. 2 (see below), it induces a corresponding axial displacement of the valve plunger to induce the valve unit to switch from its gas flow-arresting state shown in FIGS. 1A-1B into the gas flow-permitting state shown in FIG. 2, and vice versa.

The piston member 22 is associated with a flexible diaphragm 30 that is liquid-impermeable and tightly anchored to the side walls 32 of piston chamber 34 though an anchoring skirt 36. Diaphragm 30 separates between the piston member 22 and a liquid chamber 38 which is in communication through aperture 40 with liquid flow duct 42. In the liquid flow duct 42, water flows in an upstream-downstream, as represented by arrow 44. When an upstream valve (not shown) is opened, water is induced to flow (in the direction of arrow 44); this increase in flow causes increase in pressure in the liquid chamber 38.

Piston member 22 is associated with a biasing spring 46, that induces an upward bias onto the piston member, namely towards the chamber 38. Upon increase in pressure in chamber 38, there is a downward pressure on the diaphragm, represented by arrow 48, causing the diaphragm 30 and the associated piston member 22 to displace to the piston's second position shown in FIG. 2, whereupon the bottom face 50 of the piston member 22 rests against the bottom face 52 of the piston chamber 34.

Valve plunger 26 comprises O-rings 54 which in the gas flow-arresting state seen in FIGS. 1A-1B blocks passage of gas between the gas inlet port and the gas outlet port along a gas flow represented by curved arrow 56, which would occur without the valve. However, once the piston downwardly axial displaces in the second position shown in FIG. 2, the O-rings 54 are decoupled from valve seat 58 and gas flow in the general direction of arrow 56 is permitted. When the valve is shut, and there is no water flow in the duct, the pressure in chamber 38 is reduced and the piston member 22 is axially displaced to its first position shown in FIGS. 1A-1B, causing concomitant axial displacement of the valve plunger 26 into the flow-arresting state seen in FIGS. 1A-1B.

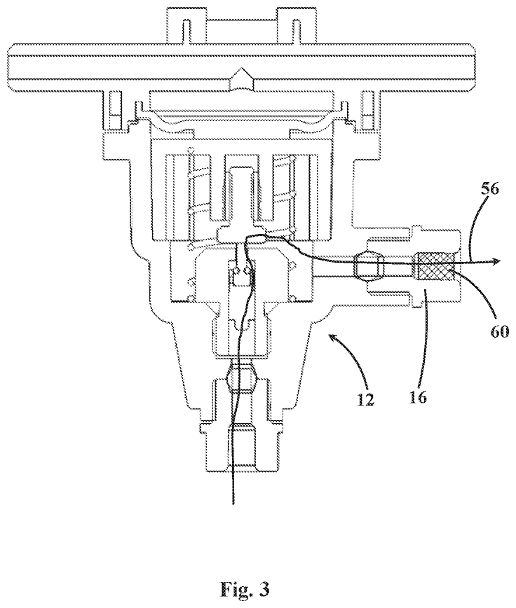

In the embodiment of FIG. 3, the gas outlet port 16 includes an anti-freeze module 60, fitted within the gas outlet port, that is configured to disrupt the flow of gas through the outlet, and hence reduce the rate of expansion of the gas. Such module functions to minimize or prevent formation of a condensate that may form at the gas outlet due to the rapid expansion of the pressurized gas once gas flow is permitted through the gas outlet. Anti-freeze module 60 may typically comprise a porous structure that is made of a high heat conducting material, e.g. a metal or an alloy.

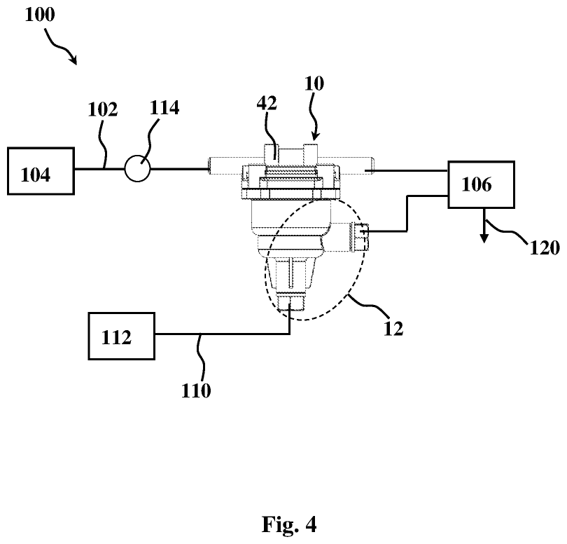

FIG. 4 is an overall schematic representation of some elements of a carbonation system 100 employing the valve of the kind seen in FIGS. 1-3. The system comprises a water flow system 102 between a water source 104 and a carbonation unit 106, while said liquid duct 42 is disposed in and constitutes part of this flow system, thus water that flows from the source 104 to the carbonation unit 106 passes through duct 42 of gas valve 10. System 100 also comprises a gas flow system 110 between a gas source 112 and the carbonation unit 106, and the gas passage 12 being disposed in and constitutes part of the gas flow system, such that carbon dioxide flows from the source to the carbonation unit through the gas passage. Water flow in water flow system 102 is controlled by means of valve 114, and once flow of water is activated, this induces a concomitant gas flow in the gas flow system 110 in a manner described above. The concomitant flow of carbon dioxide and water into the carbonation unit 106 generates carbonated water which can be dispensed through dispensing outlet 120.

1. A gas valve, comprising:
a gas passage defined between a gas inlet port and a gas outlet port and comprising a valve unit switchable between a gas flow-arresting state and a gas flow permitting state, permitting gas flow from the inlet port to the outlet port;
a piston mechanism comprising a piston member coupled to the valve unit and configured, through axial displacement of the piston member between first and second positions, to induce the valve unit to respectively switch between its gas flow-arresting state and a gas flow permitting state;
a liquid chamber in communication with a liquid flow duct such that a change in liquid pressure in said flow duct or liquid flow dynamics through said duct induces a change in static pressure within the liquid chamber to thereby induce displacement of the piston.

2. The gas valve of claim 1, wherein the piston mechanism comprises a flexible liquid-impermeable diaphragm separating between the piston member and the liquid chamber and coupled to the piston member such that deformation of the diaphragm induces displacement of the piston member.

3. The gas valve of claim 1, wherein the valve unit comprises a valve plunger disposed in a valve seat, the plunger being coupled to the piston member such that its switch between the gas flow-arresting state and the gas flow permitting state is through axial movement.

4. The gas valve of claim 3, wherein the piston member and the valve plunger are coupled to one another in a fixed manner.

5. The gas valve of claim 1, wherein the displacement of the piston member from the first to the second position is through increase in static pressure within the liquid chamber.

6. The gas valve of claim 5, wherein the piston member is biased into its first position by a biasing arrangement and the displacement into the second position is against such bias.

7. The gas valve of claim 1, wherein the displacement of the piston member from the first to the second position is through decrease in static pressure within the liquid chamber.

8. The gas valve of claim 1, further comprising an anti-freeze module fitted at or associated with the gas outlet port configured to reduce water condensation at the gas outlet port due to expansion of the gas once flow of gas is permitted through the gas outlet.

9. (canceled)

10. A water carbonation system, comprising
a water flow system between a water source and a carbonation unit;
a gas flow system between a pressurized carbon-dioxide source and the carbonation unit in which the water and the carbon-dioxide are combined to produce carbonated water; and
a gas valve according to claim 1, wherein
said liquid duct is disposed in and constitutes a part of the water flow system to channel water flow from the source to the carbonation unit to flow through said duct, and wherein
said gas passage is disposed in and constitutes a part of the gas flow system such the carbon dioxide flows from the source to the carbonation unit through said gas passage; whereby
water flow through said duct induces a change in static pressure within the liquid chamber to thereby induce displacement of the piston to permit gas flow into the carbonation unit concurrently with the flow of water.

11. The carbonation system of claim 10, comprising a liquid flow control valve upstream in the water flow system to said liquid duct, whereby opening of the valve to permit water flow through said duct increased static pressure within the water chamber to thereby cause the piston to displace from its first to its second position.
